(19) United States
(12) Patent Application Publication
(10) Pub. No.: US 2007/0104137 A1
(43) Pub. Date: May 10, 2007

(54) CHANNEL SWITCH METHOD

(75) Inventor: CHENG-WEN TANG, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,705

(22) Filed: Sep. 15, 2006

(30) Foreign Application Priority Data
Nov. 4, 2005 (CN) 200510101014.3

(51) Int. Cl. H04Q 7/00

(52) U.S. Cl. 370/329; 370/338

(57) ABSTRACT

A channel switch method is applied in a wireless communication system. The wireless communication system includes an access point and a plurality of mobile stations. The access point communicates with the plurality of mobile stations on a shared channel. The channel switch method includes transmitting a request frame from a first mobile station to the access point for a channel switch service; transmitting a channel switch frame from the access point to the first mobile station to switch the first mobile station from the shared channel to a new channel; and transmitting a beacon frame to the new channel and the shared channel.

### FIELD OF THE INVENTION

The invention relates to wireless communications, and particular to a channel switch method.

### DESCRIPTION OF RELATED ART

As mentioned in the “market requirements document (MRD) for Wi-Fi customer electronics (CE) device certification requirement by Wi-Fi certified devices seeking DLAN” in 2004, it is required that the direct link setup (DLS) is a necessary specification of MRD.

The CE devices mainly include video devices, audio devices, image devices, and voice devices. An access category (AC) level of the CE audio devices and the CE voice devices is a voice (VI) level requiring small bands, so the CE audio devices and the CE voice devices rarely employ the DLS. An AC level of the CE video devices and the CE image devices is a video (VI) level requiring large bands, so the CE video devices and the CE image devices are more likely to employ the DLS.

The DLS is mainly applied in the CE video devices and the CE image devices, and the AC level of the CE video devices and the CE image devices has a higher priority, so the DLS can easily occupy a channel, i.e., the DLS service is a high channel-occupation service. In addition, the DLS requires more bands, and as a result, bands are not enough on a shared channel with a DLS. Then communications on the shared channel may be abnormal.

Additionally, on a shared channel with a DLS, when communicating with a mobile station via the shared channel, an access point cannot provide a leased line service for the mobile station.

### SUMMARY OF THE INVENTION

An aspect of the present invention provides a channel switch method for a wireless communication system. The wireless communication system includes an access point and a plurality of mobile stations. The access point communicates with the plurality of mobile stations on a shared channel. The channel switch method includes: transmitting a request frame from a first mobile station to the access point for a channel switch service; transmitting a channel switch frame from the access point to the first mobile station to switch the first mobile station from the shared channel to a new channel; and transmitting a beacon frame to the new channel and the shared channel.

Other advantages and novel features will become more apparent from the following detailed description when taken in conjunction with the accompanying drawings, in which:

### BRIEF DESCRIPTION OF THE DRAWINGS

FIG. 1 is a schematic diagram of a frame defined by the IEEE 802.11 standard;

FIG. 2 is a schematic diagram of an action frame defined by the IEEE 802.11;

FIG. 3 is a schematic diagram of a channel switch announcement (CSA) information element (IE) defined by the IEEE 802.11;

FIG. 4 is a schematic diagram of a wireless communication system of an exemplary embodiment of the present invention;

FIG. 5 is a flowchart of a channel switch method of an exemplary embodiment of the present invention;

FIG. 6 is a flowchart of a channel switch method of another exemplary embodiment of the present invention;

FIG. 7 is a flowchart of a channel switch method of a further exemplary embodiment of the present invention;

FIG. 8 is a flowchart of a channel switch method of a still further exemplary embodiment of the present invention;

FIG. 9 is a flowchart of a channel switch method of a yet further exemplary embodiment of the present invention; and

FIG. 10 is a flowchart of a channel switch method of yet another further exemplary embodiment of the present invention.

### DETAILED DESCRIPTION OF THE INVENTION

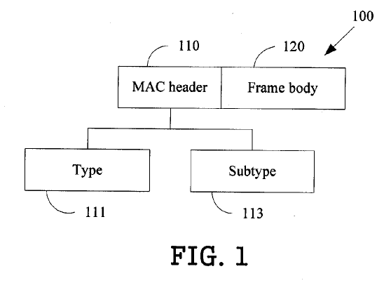

FIG. 1 is a schematic diagram of a frame 100 defined by the Institute of Electrical and Electronic Engineers (IEEE) 802.11 standard. The frame 100 includes a media access control (MAC) header 110 and a frame body 120. The MAC header 110 includes a type field 111 and a subtype field 113. The type field 111 has 2 bits, and the subtype field 113 has 4 bits. The type field 111 and the subtype field 113 respectively indicate types and subtypes of the frame 100, which are described hereinafter.

When the type field 111 and the subtype field 113 are respectively set to 00 and 0101, the frame 100 is defined as a probe response frame.

When the type field 111 and the subtype field 113 are respectively set to 00 and 1000, the frame 100 is defined as a beacon frame.

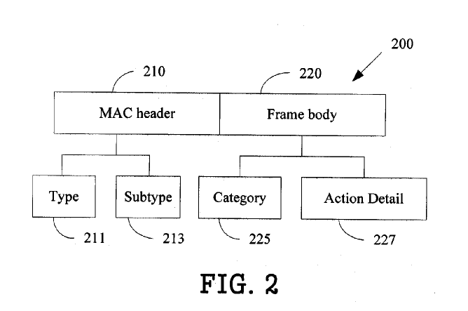

When the type field 111 and the subtype field 113 are respectively set to 00 and 1101, the frame 100 is defined as an action frame (see in FIG. 2).

When the type field 111 and the subtype field 113 are respectively set to 01 and 1011, the frame 100 is defined as a request to send (RTS) frame.

When the type field 111 and the subtype field 113 are respectively set to 01 and 1100, the frame 100 is defined as a clear to send (CTS) frame.

When the type field 111 and the subtype field 113 are respectively set to 01 and 1101, the frame 100 is defined as an acknowledgement (ACK) frame.

When the type field 111 and the subtype field 113 are respectively set to 10 and 0100, the frame 100 is defined as a null function frame.

When the type field 111 and the subtype field 113 are respectively set to 10 and 0000, the frame 100 is defined as a data frame. When the frame 100 is a data frame, the frame body 120 may include a MAC service data unit (MSDU).

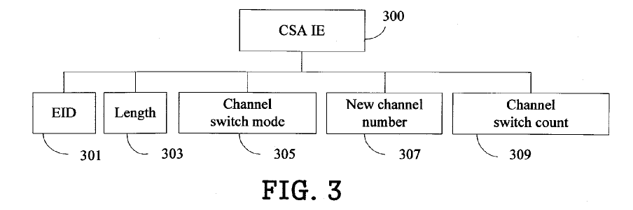

FIG. 2 is a schematic diagram of an action frame 200 defined by the IEEE 802.11. The action frame 200 includes an MAC header 210 and a frame body 220. The MAC header 210 includes a type field 211 and a subtype field 213. The type 211 and the subtype 213 are respectively set to 00 and 1101 according to the above descriptions. The frame body 220 includes a category field 225 and an action detail field 227. The category field 225 indicates categories of the action frame 200. When the category field 225 is set to 0, the action frame 200 is a frame for spectrum management, such as a channel switch announcement (CSA) frame. When the category field 225 is set to 2, the action frame 200 becomes a direct link setup (DLS) frame. The DLS frame includes a DLS request frame, a DLS response frame, and a DLS teardown frame. The action detail field 227 indicates detail information of the action frame 200. For example, the action detail field 227 may be set as a CSA information element (IE) (see in FIG. 3).

FIG. 3 is a schematic diagram of a CSA IE 300 defined by the IEEE 802.11. The CSA IE 300 can be employed in a beacon frame, an action frame, and a probe response frame. Then the beacon frame, the action frame, and the probe response frame with the CSA IE 300 represent channel switch frames. In the exemplary embodiment, the CSA IE 300 is employed in the action frame 200, that is, the action detail field 227 of the action frame 200 in FIG. 2 is set to the CSA IE 300. Then the action frame 200 becomes a CSA frame belonging to the channel switch frame.

The CSA IE 300 includes an element identifier (EID) field 301, a length field 303, a channel switch mode field 305, a new channel number field 307, and a channel switch count field 309. In the exemplary embodiment, the EID field 301 is set to 37, for indicating that the IE is a CSA IE. The length field 303 is set to 4. The channel switch mode field 305 is set to 1, for indicating data must be transmitted after channel switch. The new channel number field 307 is set to a destination channel number. The channel switch count field 309 is set to 0, and indicates the channel switch must be completed before a next beacon frame.

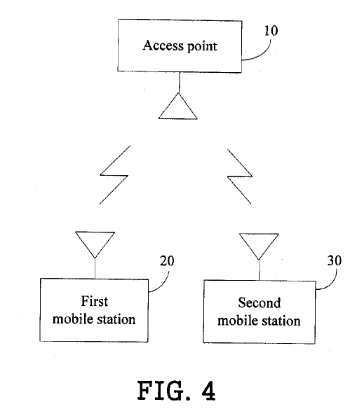

FIG. 4 is a schematic diagram of a wireless communication system of an exemplary embodiment of the present invention. In the exemplary embodiment, the wireless communication system includes an access point 10, a first mobile station 20, and a second mobile station 30. The first mobile station 20 and the second mobile station 30 may be devices that can be communicated with a wireless local area network, such as mobile phones, notebook computers, personal digital assistants (PDAs), etc. The access point 10 wirelessly communicates with the fist mobile station 20 and the second mobile station 30 on a shared channel.

In the exemplary embodiment, a channel switch method is described. The first mobile station 20 transmits a request frame to the access point for a channel switch service. The access point 10 receives the request frame, and transmits a channel switch frame to the first mobile station 20 to switch the first mobile station 20 from the shared channel to a new channel. After the channel is switched, the access point 10 transmits a beacon frame to the new channel and the shared channel. The beacon frame transmitted to the new channel by the access point 10 causes the mobile stations on the new channel keep to remain on the new channel. The beacon frame transmitted to the shared channel by the access point 10 causes the mobile stations on the shared channel to remain on the shared channel.

The request frame includes a leased line request frame and a DLS request frame. Accordingly, the channel switch service includes a leased line service and a DLS service for establishing a DLS with the second mobile station 30. When needing a leased line service, the first mobile station 20 transmits the leased line request frame to the access point 10. The leased line request frame is predefined by the first mobile station 20 and the access point 10 for requesting a leased line service. In the exemplary embodiment, the leased line request frame may be a data frame. The data frame belongs to the frame 100 of FIG. 1 including the type field 111 and the subtype field 113 respectively set to 10 and 0000. The frame body 120 includes a request MSDU including request data for the leased line service. When receiving the leased line request frame from the first mobile station 20, the access point 10 recognizes that the first mobile station 20 needs the leased line service, and does not need to send back a response frame to the first mobile station 20.

In other embodiments, the leased line request frame may also be another type of frame. In this case, after receiving the leased line request frame, the access point 10 may also need to send back a response frame to the first mobile station 20.

When needing a DLS service, the first mobile station 20 transmits the DLS request frame to the access point 10 to establish a DLS with the second mobile station 30. The access point 10 receives the DLS request frame from the first mobile station 20, and transmits another DLS request frame to the second mobile station 30 to inform the second mobile station 30 that the first mobile station 20 wants to establish a DLS with the second mobile station 30. The second mobile station 30 receives the DLS request frame from the access point 10, and transmits a DLS response frame to the access point 10 to inform the access point 10 that the second mobile station 30 agrees to establish the DLS with the first mobile station 20. The access point 10 receives the DLS response frame from the second mobile station 30, and transmits another DLS response frame to the first mobile station 20 to inform the first mobile station 20 that the second mobile station 30 agrees to establish the DLS with the first mobile station 20. In the exemplary embodiment, the DLS request frame and the DLS response frame belong to the action frame 200 of FIG. 2 including the type field 211 and the subtype field 213 respectively set to 00 and 1101. The category field 225 is set to 2. Then the DLS is established between the first mobile station 20 and the second mobile station 30. How the channel switch method of the present invention provides the leased line service and the DLS service is described hereinafter.

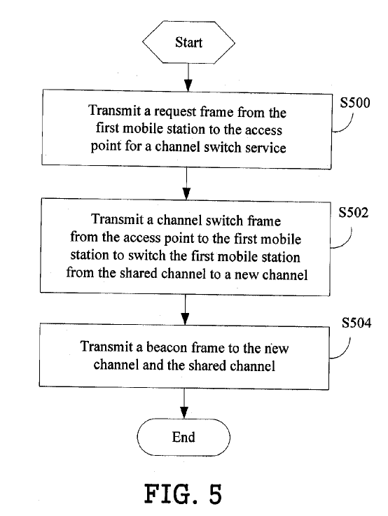

FIG. 5 is a flowchart of a channel switch method of an exemplary embodiment of the present invention. In the exemplary embodiment, the access point 10 wirelessly communicates with the first mobile station 20 and the second mobile station 30 on a shared channel, while the first mobile station 20 needs a channel switch service. In step S500, the first mobile station 20 transmits a request frame to the access point 10 for a channel switch service. In step S502, the access point 10 transmits a channel switch frame to the first mobile station 20 to switch the first mobile station 20 from the shared channel to a new channel. In step S504, the access point 10 transmits a beacon frame to the new channel and the shared channel.

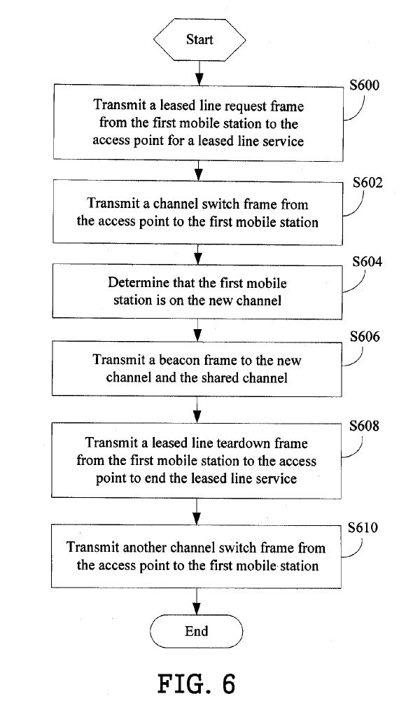

FIG. 6 is a flowchart of a channel switch method of another exemplary embodiment of the present invention. In the exemplary embodiment, the access point 10 wirelessly communicates with the first mobile station 20 and the second mobile station 30 on a shared channel, while the first mobile station 20 needs a leased line service.

In step S600, the first mobile station 20 transmits a leased line request frame to the access point 10 for a leased line service. In the exemplary embodiment, the leased line request frame is a data frame. The data frame belongs to the frame 100. When receiving the leased line request frame from the first mobile station 20, the access point 10 does not need to send back a response frame to the first mobile station 20.

In step S602, the access point 10 transmits a channel switch frame to the first mobile station 20 to switch the first mobile station 20 from the shared channel to a new channel. In the exemplary embodiment, the channel switch frame is a CSA frame. The CSA frame belongs to the action frame 200. Referring to FIG. 2 again, the type field 211 and the subtype field 213 are respectively set to 00 and 1101. The category field 225 is set to 0. The action detail field 227 is set to the CSA IE 300. Referring also to FIG. 3, the EID field 301 is set to 37. The length field 303 is set to 4. The channel switch mode field 305 is set to 1. The new channel number field 307 is set to the new channel number. The channel switch count field 309 is set to 0.

In step S604, the access point 10 determines that the first mobile station 20 is on the new channel. That is, the access point 10 determines that the channel switch is successful. In the exemplary embodiment, the access point 10 transmits a determination frame to the first mobile station 20 on the new channel. If the access point 10 receives a determination response frame from the first mobile station 20, the access point 10 determines that the first mobile station 20 is on the new channel. In the exemplary embodiment, the determination request frame may be a RTS frame, and the determination response frame may be a CTS frame. The RTS frame and the CTS frame belong to the frame 100 of FIG. 1. When the frame 100 is the RTS frame, the type field 111 and the subtype field 113 are respectively set to 01 and 1011. When the frame 100 is the CTS frame, the type field 111 and the subtype field 113 are respectively set to 01 and 1100.

In another embodiment, the determination request frame may also be a null function frame or another frame, and the determination response frame may also be an acknowledgement (ACK) frame. The null function frame and the ACK frame belong to the frame 100 of FIG. 1. When the frame 100 is the null function, the type field 111 and the subtype field 113 are respectively set to 10 and 0100. When the frame 100 is the ACK frame, the type field 111 and the subtype field 113 are respectively set to 01 and 1101.

In step S606, the access point 10 transmits a beacon frame to the new channel and the shared channel. In the exemplary embodiment, the access point 10 provides the leased line service for the first mobile station 20 on the new channel. At each beacon interval, the access point 20 may initially transmit the beacon frame to the new channel. Then the access point 10 goes to the shared channel to transmit the beacon frame to the shared channel. Afterwards, the access point 10 goes back to the new channel, and further provides the leased line service for the first mobile station 20. The beacon frame transmitted to the shared channel can keep the mobile stations on the shared channel, avoiding the mobile stations on the shared channel from going to the new channel to affect the leased line service. The beacon frame transmitted to the new channel by the access point 10 is used for providing the leased line service on the new channel.

In other embodiments, at each interval, the access point 10 may also first transmit the beacon frame to the shared channel. Then the access point 10 goes back to the new channel to transmit the beacon frame to the new channel. Afterwards, the access point 10 further provides the leased line service.

In step S608, the first mobile station 20 transmits a leased-line teardown frame to the access point 10 to end the leased line service. In the exemplary embodiment, the leased-line teardown frame is predefined by the first mobile station 20 and the access point 10 to end the leased line service. In the exemplary embodiment, the leased-line teardown frame may be a data frame. The data frame belongs to the frame 100 of FIG. 1 including the type field 111 and the subtype field 113 respectively set to 10 and 0000. The frame body 120 includes a teardown MSDU including request data for ending the leased line service. When receiving the leased-line teardown frame from the first mobile station 20, the access point 10 is informed that the first mobile station 20 wants to end the leased line service, and the access point 10 does not need to send back a response frame to the first mobile station 20.

In other embodiments, the leased line request frame may also be another type of frame. In this case, after receiving the leased line request frame, the access point 10 may need to send back a response frame to the first mobile station 20.

In step S610, the access point 10 transmits another channel switch frame to the first mobile station 20 to switch the first mobile station 20 from the new channel to the shared channel. In the exemplary embodiment, the channel switch frame is a CSA frame. The CSA frame belongs to the action frame 200. Referring to FIG. 2 again, the type field 211 and the subtype field 213 are respectively set to 00 and 1101. The category field 225 is set to 0. The action detail field 227 is set to the CSA IE 300. Referring also to FIG. 3 again, the EID field 301 is set to 37. The length field 303 is set to 4. The channel switch mode field 305 is set to 1. The new channel number field 307 is set to the switched shared channel. The channel switch count field 309 is set to 0.

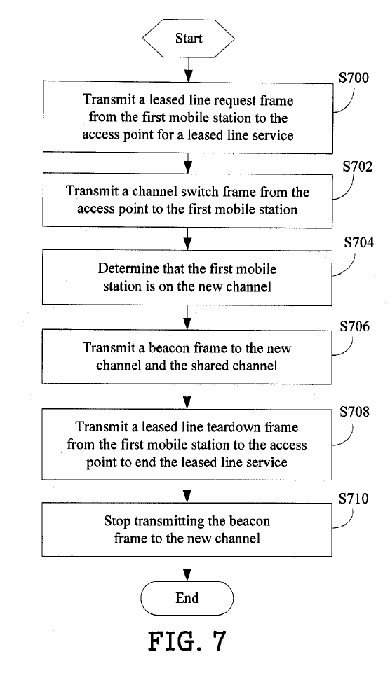

In another embodiment, in the step S610 of FIG. 6, the access point 10 may not need to transmit the channel switch frame to the first mobile station 20. Referring to FIG. 7, the steps of S700, S702, S704, S706, and S708 of FIG. 7 are all the same as the steps of S600, S602, S604, S606, and S608 of FIG. 6, respectively, so the descriptions are omitted. In step S710, the access point 10 stops transmitting the beacon frame to the new channel. In the exemplary embodiment, if the first mobile station 20 cannot scan the beacon frame transmitted by the access point 10 on the new channel, the first mobile station 20 will roam back to the shared channel.

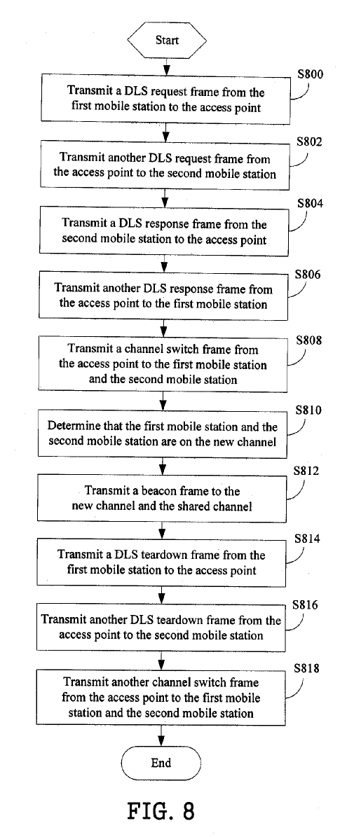

FIG. 8 is a flowchart of a channel switch method of a still further exemplary embodiment of the present invention. In the exemplary embodiment, the access point 10 wirelessly communicates with the first mobile station 20 and the second mobile station 30 on a shared channel, while the first mobile station 20 needs to establish a DLS with the second mobile station 30.

In step S800, the first mobile station 20 transmits a DLS request frame to the access point 10 to establish a DLS with the second mobile station 30. In step S802, the access point 10 transmits another DLS request frame to the second mobile station 30 to inform the second mobile station 30 that the first mobile station 20 wants to establish the DLS with the second mobile station 30. In step S804, the second mobile station 30 transmits a DLS response frame to the access point 10 to inform the access point 10 that the second mobile station 30 agrees to establish the DLS with the first mobile station 20. In step S806, the access point 10 transmits another DLS response frame to the first mobile station 20 to inform the first mobile station 20 that the second mobile station 30 agrees to establish the DLS with the first mobile station 20. In the exemplary embodiment, the DLS request frame and the DLS response frame belong to the action frame 200 of FIG. 2 including the type field 211 and the subtype field 213 respectively set to 00 and 1101. The category field 225 is set to 2.

In step S808, the access point 10 transmits a channel switch frame to the first mobile station 20 and the second mobile station 30 to switch the first mobile station 20 and the second mobile station 30 from the shared channel to a new channel. In the exemplary embodiment, the channel switch frame may be a CSA frame. The CSA frame belongs to the action frame 200. Referring to FIG. 2, the type field 211 and the subtype field 213 are respectively set to 00 and 1101. The category field 225 is set to 0. The action detail field 227 is set to the CSA IE 300. Then the action frame 200 becomes the CSA frame. Referring also to FIG. 3, the EID field 301 is set to 37. The length field 303 is set to 4. The channel switch mode field 305 is set to 1. The new channel number field 307 is set to the new channel number. The channel switch count field 309 is set to 0.

In step S810, the access point 10 determines that the first mobile station 20 and the second mobile station 30 are on the new channel. That is, the access point 10 determines that the channel switch is successful. In the exemplary embodiment, the access point 10 transmits a determination frame to the first mobile station 20 and the second mobile station 30 on the new channel. If the access point 10 receives a determination response frame from both of the first mobile station 20 and the second mobile station 30, the access point 10 determines that the first mobile station 20 and the second mobile station 30 are on the new channel. In the exemplary embodiment, the determination request frame may be a RTS frame, and the determination response frame may be a CTS frame. The RTS frame and the CTS frame belong to the frame 100 of FIG. 1. When the type field 111 and the subtype field 113 are respectively set to 01 and 1011, the frame 100 is the RTS frame. When the type field 111 and the subtype field 113 are respectively set to 01 and 1100, the frame 100 is the CTS frame.

In other embodiment, the determination request frame may also be a null function frame or another frame, and the determination response frame may also be an ACK frame. The null function frame and the ACK frame belong to the frame 100 of FIG. 1. When the frame 100 is the null function, the type field 111 and the subtype field 113 are respectively set to 10 and 0100. When the frame 100 is the ACK frame, the type field 111 and the subtype 113 are respectively set to 01 and 1101.

In step S812, the access point 10 transmits a beacon frame to the new channel and the shared channel. In the exemplary embodiment, the access point 10 provides services for mobile stations on the shared channel. At each beacon interval, the access point 20 may transmit the beacon frame to the shared channel. Then the access point 10 goes to the new channel, and transmits the beacon frame to the new channel. Afterwards, the access point 10 goes back to the shared channel, and continues to provide services for the mobile stations on the shared channel. The beacon frame transmitted to the new channel is used for making the first mobile station 20 and the second mobile station 30 remain on the new channel, avoiding the first mobile station 20 and the second mobile station 30 from going to the shared channel. The beacon frame transmitted to the shared channel by the access point 10 is used for providing the services for the mobile stations on the shared channel.

In other embodiments, at each interval, the access point 10 may also first transmit the beacon frame to the new channel. Then the access point 10 goes back to the shared channel to transmit the beacon frame to the shared channel. Afterwards, the access point 10 continues to provide services for the mobile stations on the shared channel.

In step S814, the first mobile station 20 transmits a DLS teardown frame to the access point 10 to end the DLS service. In the exemplary embodiment, the DLS teardown frame belongs to the action frame 200 of FIG. 2 including the type field 211 and the subtype field 213 respectively set to 00 and 1101. The category field 225 is set to 2.

In step S816, the access point 10 transmits another DLS teardown frame to the second mobile station 30.

In step S818, the access point 10 transmits another channel switch frame to the first mobile station 20 and the second mobile station 30 to switch the first mobile station 20 and the second mobile station 30 from the new channel to the shared channel. In the exemplary embodiment, the channel switch frame may be a CSA frame. The CSA frame belongs to the action frame 200. Referring to FIG. 2 again, the type field 211 and the subtype 213 are respectively set to 00 and 1101. The category field 225 is set to 0. The action detail field 227 is set to the CSA IE 300. Then the action frame 200 becomes the CSA frame. Referring also to FIG. 3 again, the EID field 200 is set to 37. The length field 303 is set to 4. The channel switch mode field 305 is set to 1. The new channel number field 307 is set to the shared channel number. The channel switch count field 309 is set to 0.

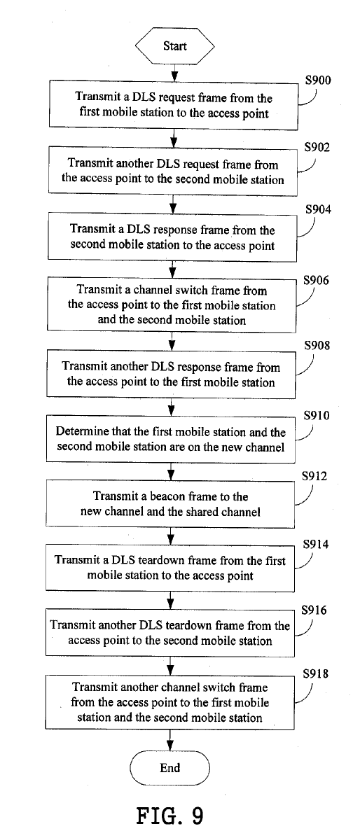

In another embodiment, the sequences of the steps S806 and S808 may be exchanged. Referring to FIG. 9, the steps of S900, S902, S904, S910, S912, S914, S916, and S918 of FIG. 9 are all the same as the steps of S800, S802, S804, S810, S812, S814, S816, and S818 of FIG. 8, so the descriptions are omitted. In step S906, the access point 10 first transmits a channel switch frame to the first mobile station 20 and the second mobile station 30 to switch the first mobile station 20 and the second mobile station 30 from the shared channel to the new channel. Then the access point 10 goes to the new channel. In step S908, the access point 10 transmits another DLS response frame to the first mobile station 20 on the new channel.

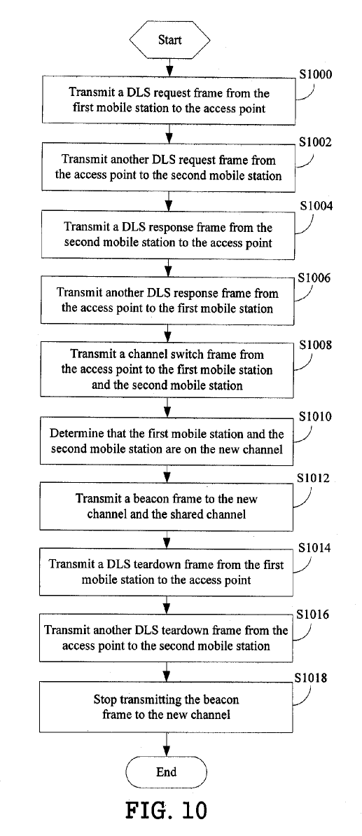

In a further embodiment, in step S818 of FIG. 8, the access point 10 may not need to transmit the channel switch frame to the first mobile station 20 and the second mobile station 30. Referring to FIG. 10, the steps S1000, S1002, S1004, S1006, S1008, S1010, S1012, S1014, and S1016 of FIG. 10 are the same as the steps S800, S802, S804, S806, S808, S810, S812, S814, and S816 of FIG. 8, so the descriptions are omitted. In step S1018, the access point 10 stops transmitting the beacon frame to the new channel. In the exemplary embodiment, if the first mobile station 20 and the second mobile station 30 cannot scan the beacon frame transmitted by the access point 10 on the new channel, the first mobile station 20 and the second mobile station 30 will roam back to the shared channel.

In the exemplary embodiment of the present invention, the access point 10 may provide a leased line service for the first mobile station 20, and may provide a DLS service for the first mobile station 20 and the second mobile station 30.

While various embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A channel switch method, for a wireless communication system, the wireless communication system comprising an access point and a plurality of mobile stations, the access point communicating with the plurality of mobile stations on a shared channel, the method comprising:
transmitting a request frame from a first mobile station to the access point for a channel switch service;
transmitting a channel switch frame from the access point to the first mobile station to switch the first mobile station from the shared channel to a new channel; and
transmitting a beacon frame to the new channel and the shared channel.

2. The method as claimed in claim 1, wherein the channel switch frame comprises a channel switch announcement (CSA) information element (IE).

3. The method as claimed in claim 1, wherein the request frame comprises a leased line request frame, and the channel switch service comprises a leased line service.

4. The method as claimed in claim 3, wherein the step of transmitting a request frame from a first mobile station to the access point for a channel switch service comprises:
transmitting the leased line request frame from the first mobile station to the access point for the leased line service.

5. The method as claimed in claim 4, further comprising:
determining that the first mobile station is on the new channel.

6. The method as claimed in claim 5, wherein the determining step comprises:
transmitting a determination request frame from the access point to the first mobile station; and
receiving a determination response frame from the first mobile station.

7. The method as claimed in claim 6, wherein the determination request frame is a request to send (RTS) frame, and the determination response frame is a clear to send (CTS) frame.

8. The method as claimed in claim 6, wherein the determination request frame is a null function frame, and the determination response frame is an acknowledgement (ACK) frame.

9. The method as claimed in claim 5, further comprising:
transmitting a leased-line teardown frame from the first mobile station to the access point to end the leased line service.

10. The method as claimed in claim 9, further comprising:
transmitting another channel switch frame from the access point to the first mobile station to switch the first mobile station from the new channel to the shared channel.

11. The method as claimed in claim 9, further comprising:
stopping transmitting the beacon frame to the new channel.

12. The method as claimed in claim 1, wherein the request frame comprises a direct link setup (DLS) request frame, and the channel switch service comprises a DLS service for establishing a DLS with a second mobile station.

13. The method as claimed in claim 12, wherein the step of transmitting a request frame from a first mobile station to the access point for a channel switch service comprises:
transmitting the DLS request frame from the first mobile station to the access point to establish the DLS with the second mobile station;
transmitting another DLS request frame from the access point to the second mobile station;
transmitting a DLS response frame from the second mobile station to the access point; and
transmitting another DLS response frame from the access point to the first mobile station.

14. The method as claimed in claim 13, further comprising:
transmitting the channel switch frame from the access point to the second mobile station; and
determining that the first mobile station and the second mobile station are on the new channel.

15. The method as claimed in claim 14, wherein the determining step comprises:
transmitting a determination request frame from the access point to the first mobile station and the second mobile station; and
receiving a determination response frame from the first mobile station and the second mobile station.

16. The method as claimed in claim 15, wherein the determination request frame is a request to send (RTS) frame, and the determination response frame is a clear to send (CTS) frame.

17. The method as claimed in claim 15, wherein the determination request frame is a null function frame, and the determination response frame is an acknowledgement (ACK) frame.

18. The method as claimed in claim 14, further comprising:
transmitting a DLS teardown frame from the first mobile station to the access point to end the DLS; and
transmitting another DLS teardown frame from the access point to the second mobile station.

19. A method to manage a shared channel, comprising the steps of:
establishing communication between an access point and a plurality of mobile stations on a shared channel;
requesting said access point for a channel occupation service comprising a leased line service and a direct link setup (DLS) service by one of said plurality of mobile stations;
generating a channel switch announcement (CSA) frame by said access point based on said requested channel occupation service;
switching said one of said plurality of mobile stations from said shared channel to a new channel according to said CSA frame after said access point transmits said CSA frame to said one of said plurality of mobile stations; and
continuing to transmit a beacon frame to said shared channel and said new channel by said access point to maintain service of said shared channel and said new channel, respectively.

20. A method to manage a shared channel, comprising the steps of:
establishing communication between an access point and a plurality of mobile stations on a shared channel;
requesting said access point for a channel occupation service comprising a leased line service and a direct link setup (DLS) service by one of said plurality of mobile stations;
transmitting a channel switch frame generated by said access point based on said requested channel occupation service from said access point to said one of said plurality of mobile stations; and
switching said one of said plurality of mobile stations from said shared channel to a new channel according to said transmitted channel switch frame in order for performing said channel occupation service on said new channel.
